(19) United States
(12) Patent Application Publication
(10) Pub. No.: US 2024/0391216 A1
(43) Pub. Date: Nov. 28, 2024

(54) HEATED GLAZING WITH TEMPERATURE CONTROL

(71) Applicant: AGC GLASS EUROPE, Louvain-la-Neuve (BE)

(72) Inventors: Soufiane EL ABDOUNI, Gosselies (BE); Jean MASSON, Gosselies (BE); Xavier LALOYAUX, Gosselies (BE); Julien PRUNIER, Gosselies (BE)

(73) Assignee: AGC GLASS EUROPE, Louvain-la-Neuve (BE)

(21) Appl. No.: 18/689,246

(22) PCT Filed: Sep. 26, 2022
(86) PCT No.: PCT/EP2022/076643

§ 371 Date: Mar. 5, 2024

(30) Foreign Application Priority Data
Oct. 6, 2021 (EP) 21201308.0

(51) Int. Cl. B32B 17/10; B32B 27/08; H05B 3/84

(52) U.S. Cl. CPC B32B 17/10385; B32B 17/10036; B32B 17/10761; B32B 27/08; H05B 3/84; B32B 2607/00

(57) ABSTRACT

An automotive glazing for a vehicle, the automotive glazing being configured to be placed in front of an optical sensor. The automotive glazing contains an internal face configured to face the optical sensor, an external face configured to face an outside of the vehicle, and a heating circuit on the internal face of the automotive glazing. The heating circuit includes conductive wires printed on the internal face of the automotive glazing, and a printed circuit board.

### FIELD OF THE INVENTION

The present invention relates to the field of automotive heated glazing. More specifically it relates to systems and methods to control temperature of such heated glazing.

### BACKGROUND OF THE INVENTION

In the scope of autonomous driving, it is important to keep the vision of the various optical sensors used on autonomous or semi-autonomous cars free from any obstruction to allow functionality under any weather condition. Frosted or misted glazing in front of an optical sensor usually disturbs or eventually prevents the optical sensor to acquire date. It is therefore of tremendous importance to defrost or demist as quick as possible, which is done through heating of the glazing.

Various solutions are known from the skilled in the art in order to heat an automotive glazing. Amongst these solutions, one consists of printing electrically conductive wires (usually silver wires) on the glazing. These conductive wires are then powered, producing heat that will defrost or demist the glazing.

The heating of an automotive glazing is usually limited so that the temperature of the glazing is kept below a maximal temperature value. For example, in Europe, a windshield of a car cannot be heated above 70° C. as the driver of the vehicle may touch the windshield while driving. It is also usually recommended not to heat any automotive glazing above a maximal temperature value. Moreover, and specifically regarding laminated automotive glazing, the maximal temperature value to which the glazing is heated is linked to the laminate itself. A laminated glazing (or laminate) is a type of safety glass that holds together when shattered. In the event of breaking, it is held in place by an interlayer, typically of polyvinyl butyral (PVB), ethylene-vinyl acetate (EVA) or Thermoplastic Polyurethane (TPU), between its two or more layers of glass. The interlayer keeps the layers of glass bonded even when broken, and its high strength prevents the glass from breaking up into large sharp pieces. Increasing the temperature of the glazing may damage the interlayer which is less resistant to high temperature than glass.

Such heating system usually uses voltage coming from the battery of the automotive vehicle. The voltage usually ranges from 9V to 16V. To limit the temperature reached by the glazing, a resistance is added to the heating circuit in order to limit the received voltage. The heating time is also defined so that the temperature of the glazing will never exceed the maximal temperature value. There is therefore no need to control the temperature of the glazing as both the resistance and the heating time have been predefined in order to never reach such maximal temperature value.

However the actual tendency in automotive is towards defrosting or demisting as fast as possible. In order to heat the glazing as fast as possible, more power must be brought to the conductive wires. There are two possibilities: either the voltage at the entry of the heating circuit is increased, either the resistance of the heating circuit is decreased. The temperature of the glazing is therefore subjected to reach and exceed the maximal temperature value. It is therefore needed to know the temperature of the glazing during the heating.

Moreover, as the resistance of the heating circuit is lower and as the voltage may vary between 9 and 16V, it is needed to regulate accurately the heating of the glazing. Otherwise the temperature of the glazing may exceed the maximal temperature value. The regulation can be done by a signal given by the optical sensor that the glazing is defrosted or demisted. However, this signal is only given when the glazing is completely defrosted or demisted in the whole field of view (FOV) of the optical sensor. This leads to residual heat in the conductive wires which is dissipating for nothing. Besides, such regulation done by the optical sensor does not allow to avoid the voltage variation of the battery.

There is therefore a need for a solution to regulate the temperature of conductive wires printed on an automotive glazing, allowing to defrost or demist quickly but without exceeding the maximum temperature value supported by the glazing.

### SUMMARY OF THE INVENTION

The present invention concerns an automotive glazing for a vehicle. The automotive glazing is configured to be placed in front of an optical sensor. The automotive glazing comprises an internal face configured to face the optical sensor, an external face configured to face the outside of the vehicle and a heating circuit on the internal face of the automotive glazing. The heating circuit comprises conductive wires printed on the internal face of the automotive glazing. The heating circuit further comprises a printed circuit board comprising an internal face and an external face, the external face being placed on the internal face of the automotive glazing. The printed circuit board is connected to the conductive wires. The printed circuit board comprises on its internal face a control circuit configured to control the heating circuit. The printed circuit board further comprises on its internal face an active regulation system configured to be connected to a battery of the vehicle. The automotive glazing further comprises at least one thermistor fixed on the internal face of the automotive glazing. The thermistor is connected to the control circuit.

The invention also relates to the use of an automotive glazing as a windshield, a rearlite or a sidelite of a vehicle. It also relates to the use of an automotive glazing as a cover of an optical sensor mounted on or inside a vehicle. It also relates to the use of an automotive glazing as a part of an exterior trim element of a vehicle.

### BRIEF DESCRIPTION OF THE DRAWINGS

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1 illustrates an embodiment of an automotive glazing according to the invention.

FIG. 2a illustrates another embodiment of an automotive glazing according to the invention.

FIG. 2b illustrates a side view of this embodiment.

FIG. 3 illustrates another embodiment of an automotive glazing according to the invention.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes an automotive glazing. Automotive glazing refers to a glazing adapted for a vehicle. A vehicle includes car, van, lorry, motorbike, bus, tram, train, drone, airplane, helicopter and the like.

The automotive glazing is configured to be placed in front of an optical sensor. An optical sensor is understood as a sensor which has at least a receiver active in the ultraviolet, visible or infrared wavelength, such as a camera or a rain sensor. It can also further comprise an emitter active in the ultraviolet, visible or infrared wavelength, such as a lidar.

The automotive glazing has an internal face and an external face. The internal face is facing the optical sensor, while the external face faces the outside of the vehicle.

The automotive glazing further comprises a heating circuit on its internal face. The heating circuit comprises conductive wires and a printed circuit board (PCB).

The conductive wires are printed on the internal face of the automotive glazing. The conductive wires are made of a conductive material. The conductive material may refer to a conductive ink or to a conductive paste. Conductive ink may refer, for example, to a silver ink for screen printing, for which a super fine silver powder is dispersed uniformly into a polyester resin in order to create a silver ink, with a solid content usually between 70% and 85%. Conductive ink may also refer to a carbon ink for ink printing, with a solid content usually between 35% and 40%. Conductive ink may also refer to a silver paste for screen printing with a silver content ranging between 55% and 85%. Conductive ink may also refer to a silver ink for inkjet, with 30% to 40% of metal loading. Conductive ink may also refer to a silver ink for aerosol jet, with a silver content around 50%. These are only examples of current conductive ink and conductive paste and do not restrain the realization of the present invention with another type of conductive ink or conductive paste.

The PCB of the heating circuit comprises an internal face and an external face. The external face of the PCB is placed on the internal face of the automotive glazing. The PCB is connected to the conductive wires. The PCB also comprises on its internal face a control circuit configured to control the heating circuit.

The PCB of the heating circuit further comprises on its internal face an active regulation system. This active regulation system maintains a constant voltage output even when changing input voltages and output currents. The active regulation system is connected to a battery of the vehicle. The advantage of using an active regulation system is to allow to stabilize the voltage coming from the battery of the vehicle. As an example, the voltage of a car can range from 4.5V to 36V. Using an active regulation system allows to stabilize the voltage at for example 5V. The control circuit of the heating circuit can therefore be alimented with a stabilized source.

The automotive glazing further comprises at least one thermistor. A thermistor is a type of resistor whose resistance is dependent on temperature. It can therefore furnish information about temperature. There also exist electronic thermistors which give a signal with a frequency varying depending on the temperature. The thermistor is further connected to the control circuit. The connection between the thermistor and the control circuit can be done through an electronic track on the automotive glazing itself.

According to a preferred embodiment, the active regulation system is a DC-DC converter. A DC-DC converter is a high-frequency power conversion circuit. It uses high-frequency switching and inductors, transformers and capacitors to smooth out switching noise into regulated DC voltages. It maintains a constant voltage output even when changing input voltages and output currents.

According to a preferred embodiment, the thermistor is fixed on the internal face of the automotive glazing through a thermal conductive tape. The thermal conductive tape is a low-cost element. It allows a very simple way to fix the thermistor on a pane, especially compared to a thermistor which would be welded on an automotive glazing. It also offers the advantage of applying very low constraint on the automotive glazing itself.

According to a preferred embodiment, the at least one thermistor is fixed on the external face of the PCB. This way there is no need to add an electronic track on the automotive glazing to rely the thermistor to the control circuit, as it is done through the PCB itself.

According to a preferred embodiment, the at least one thermistor is in contact with a part of the conductive wires of the heating circuit through the thermal conductive tape. Such configuration allows for precise measurement of the temperature of the conductive wires, and therefore to detect overheating which may lead to breakage of the conductive wires.

According to a preferred embodiment, the automotive glazing is made of glass or plastic or a combination thereof. The automotive glazing can be a monolithic glass or a laminate, meaning two sheets of glass joined together by an interlayer (such as a PVB interlayer). The glass can be tempered or semi-tempered, either by heat tempering or chemical tempering. The glass can be hot or cold bended.

According to a preferred embodiment, the automotive glazing is a windshield, a rearlite or a sidelite. An automotive glazing includes vision glazings, meaning glazings through which visible light is able to pass, such as windshield, rearlite and sidelites (glazings installed on either sides of an automotive vehicle to allow passenger of such vehicle to see through).

According to a preferred embodiment, the automotive glazing is a cover of an optical sensor mounted on or inside the vehicle.

According to a preferred embodiment, the automotive glazing is a part of an exterior trim element. An exterior trim element is understood as. An exterior trim element includes bumper, window/door seal, wheel well, fender, headlight, mirror body and roof cover. Vehicle manufacturers use these exterior trim elements to add aesthetics, increase function, and add flexibility to the vehicle design.

According to a preferred embodiment, the optical sensor is a lidar and the automotive glazing is transparent at the operating wavelength range of the lidar.

The present invention also concerns the use of an automotive glazing as described previously as a windshield, a rearlite or a sidelite of a vehicle.

The present invention also concerns the use of an automotive glazing as described previously as a cover of an optical sensor mounted on or inside a vehicle.

The present invention also concerns the use of an automotive glazing as described previously as a part of an exterior trim element of a vehicle.

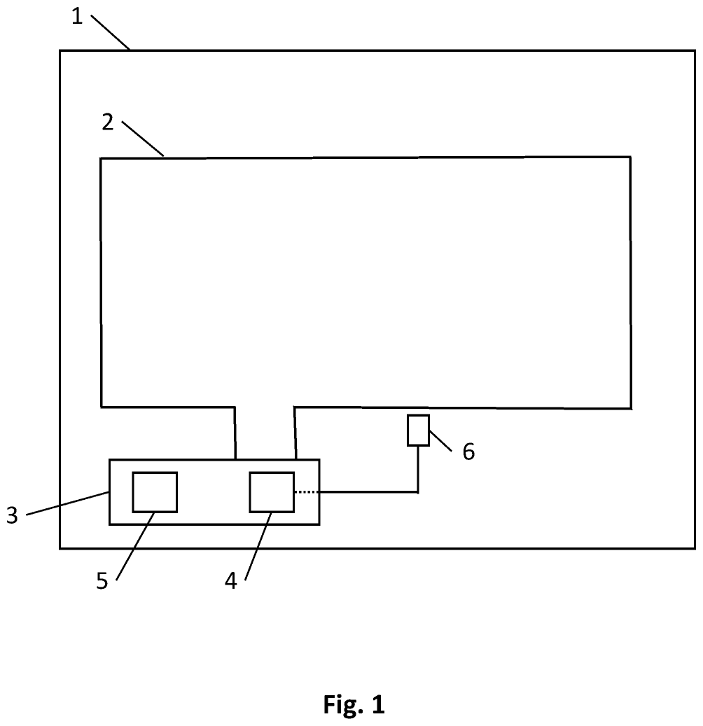

FIG. 1 shows an automotive glazing (1). The automotive glazing (1) comprises a heating circuit. The heating circuit comprises conductive wires (2). The conductive wires in this figure are shown as peripheral. However, other pattern of conductive wires can be used, for example a snake pattern. Depending on the width of the conductive wires as well as the optical sensor placed behind, the conductive wires can be placed out or in the field of view of the optical sensor. These conductive wires (2) are heated in order to defrost or demist the automotive glazing (1). The heating circuit also comprises a printed circuit board (PCB) (3). The PCB (3) comprises a control circuit (4). The control circuit (4) allows to control the heating of the conductive wires (2). The PCB (3) further comprises an active regulation system, such as a DC-DC converter (5). Both the control circuit (4) and the active regulation system (5) are on the internal face of the PCB (3). The automotive glazing (1) further comprises a thermistor (6). The thermistor is connected to the control circuit (4). The thermistor (6) can be glued on the automotive glazing (1) through a thermal conductive tape (not shown on this figure).

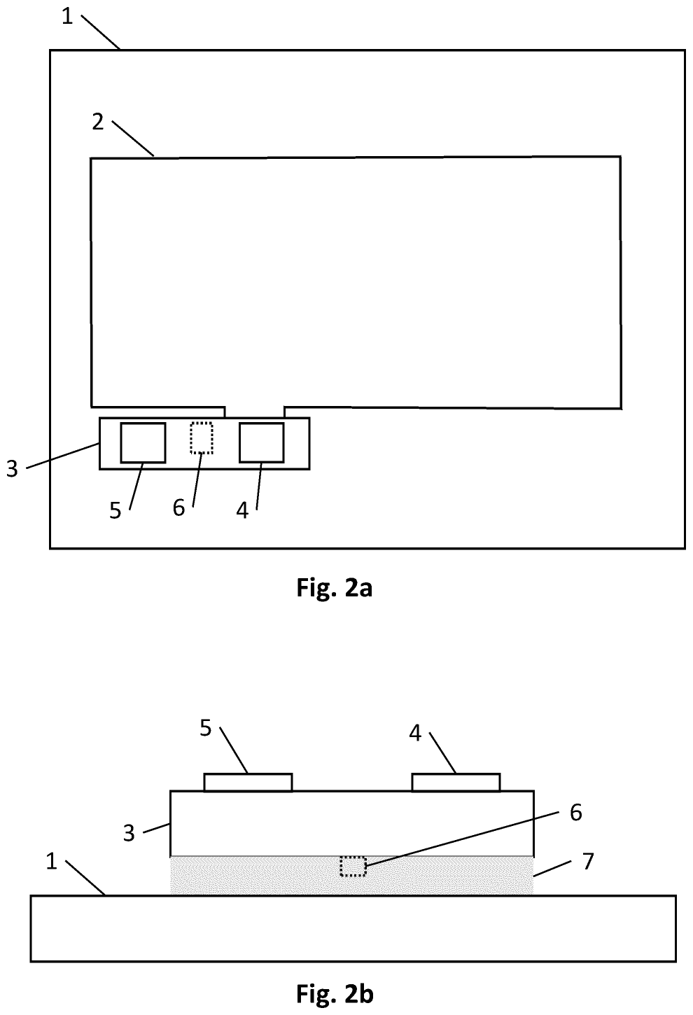

FIG. 2a also shows an automotive glazing (1). In this embodiment, the thermistor (6) is placed on the external face of the PCB (3). As shown on FIG. 2b, in this embodiment, the thermistor (6) is embedded in a thermal conductive tape (7) which is adhered to the automotive glazing (1).

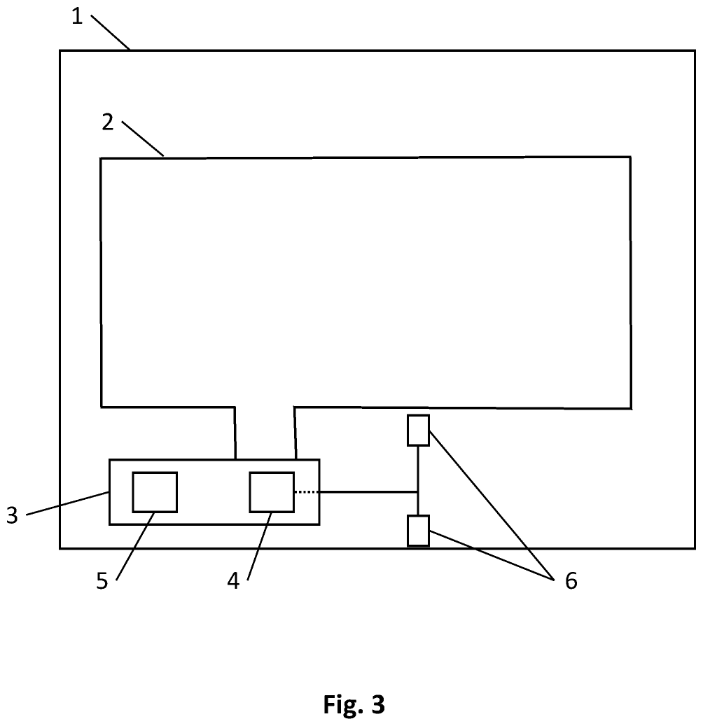

FIG. 3 also shows an automotive glazing (1). In this embodiment, the automotive glazing (1) comprises two thermistors (6), both connected to the control circuit (4). Both thermistors are fixed on the automotive glazing (1), for example through a thermal conductive tape (not shown on this figure). Such configuration allows to better check the diffusion of the heat from the conductive wires to the automotive glazing.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. An automotive glazing for a vehicle, the automotive glazing being configured to be placed in front of an optical sensor,
wherein the automotive glazing comprises:
an internal face configured to face the optical sensor;
an external face configured to face an outside of the vehicle; and
a heating circuit on the internal face of the automotive glazing,
wherein the heating circuit comprises:
conductive wires printed on the internal face of the automotive glazing; and
a printed circuit board comprising an internal face and an external face, the external face being placed on the internal face of the automotive glazing, the printed circuit board being connected to the conductive wires, the printed circuit board comprising on its internal face a control circuit configured to control the heating circuit;
wherein the printed circuit board further comprises on its internal face an active regulation system configured to be connected to a battery of the vehicle, and
wherein the automotive glazing further comprises at least one thermistor fixed on the internal face of the automotive glazing, the at least one thermistor being connected to the control circuit.

2. The automotive glazing according to claim 1, wherein the active regulation system is a DC/DC converter.

3. The automotive glazing according to claim 1, wherein the at least one thermistor is fixed on the internal face of the automotive glazing through a thermal conductive tape.

4. The automotive glazing according to claim 1, wherein the at least one thermistor is fixed on the external face of the printed circuit board.

5. The automotive glazing according to claim 1, wherein the at least one thermistor is in contact with a part of the conductive wires of the heating circuit through a thermal conductive tape.

6. The automotive glazing according to claim 1, wherein the automotive glazing is made of glass, plastic or a combination thereof.

7. The automotive glazing according to claim 1, wherein the automotive glazing is a monolithic glazing or a laminated glazing.

8. The automotive glazing according to claim 1, wherein the automotive glazing is a windshield, a rearlite, or a sidelite.

9. The automotive glazing according to claim 1, wherein the automotive glazing is a cover of an optical sensor mounted on or inside the vehicle.

10. The automotive glazing according to claim 1, wherein the automotive glazing is a part of an exterior trim element.

11. The automotive glazing according to claim 1, wherein the optical sensor is a lidar and the automotive glazing is transparent at an operating wavelength range of the lidar.

12. A windshield, a rearlite, or a sidelite of a vehicle comprising the automotive glazing of claim 1.

13. A cover of an optical sensor mounted on or inside a vehicle comprising the automotive glazing of claim 1.

14. An exterior trim element of a vehicle comprising the automotive glazing of claim 1.
